(19) United States
(12) Patent Application Publication
(10) Pub. No.: US 2018/0222294 A1
(43) Pub. Date: Aug. 9, 2018

(54) LIGHTWEIGHT LATCH WITH CLINCH NUT

(71) Applicant: Magna Closures Inc., Newmarket (CA)

(72) Inventors: Francesco CUMBO, Pisa (IT); Carlo QUARTIERI, Pontedera (PI) (IT); Enrico BOERI, Camaiore (Lucca) (IT)

(21) Appl. No.: 15/883,312

(22) Filed: Jan. 30, 2018

Related U.S. Application Data
(60) Provisional application No. 62/456,802, filed on Feb. 9, 2017.

(51) Int. Cl. B60J 5/04; E05C 3/16; E05C 3/24

(52) U.S. Cl. CPC B60J 5/0431; B60J 5/0483; E05Y 2900/531; E05C 3/162; E05C 3/24; B60J 5/0413

(57) ABSTRACT

A latch assembly for a vehicle door closure system is provided, with latch assembly having a strength module including a frame plate, a latching mechanism with components pivotably mounted by clinch nuts secured to retention apertures formed in the frame plate, and threaded fasteners in threaded engagement with the clinch nuts to mount the latch assembly to the vehicle door.

### CROSS-REFERENCE TO RELATED APPLICATION

This application claims the benefit of U.S. Provisional Application Ser. No. 62/456,802, filed Feb. 9, 2017, which is incorporated herein by reference in its entirety.

### FIELD

The present disclosure relates generally to automotive door latches. More particularly, the present disclosure is directed to a side door latch assembly equipped with a lightweight strength module.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed, lock the door in its closed position, and unlatch and release the door to permit subsequent movement of the door to its open position. As is also well known, the latch assembly is configured to include a latch mechanism for latching the door, a lock mechanism interacting with the latch mechanism for locking the door, and a release mechanism interacting with the lock mechanism for unlocking and unlatching the door. These mechanisms can be manually-operated and/or power-operated to provide the desired level of standard features. In known latch assemblies, a strength module is configured to include a structural frame plate and one or more back plates having aligned mounting bosses formed with internally-threaded apertures configured to receive threaded fasteners for mounting the latch assembly to a structural portion of the door. The frame plate and back plate(s) cooperate to define a latch chamber within which the latch mechanism is located. Typically, the latch mechanism, which is also part of the strength module, includes a ratchet and pawl arrangement with both components pivotably supported on pivot pins extending from the frame plate. Obviously, the physical dimensions and materials selected for the strength module, including the frame plate and back plate(s) must be selected to withstand the forces associated with motor vehicle door closure systems. It is desirable to reduce the weight of the strength module as part of a desired objective to reduce the overall weight of the vehicle for improving fuel efficiency. One manner to reduce the weight of the strength module, for example, is by reducing the thickness of the frame plate. However, there are drawbacks in doing so. One drawback is the decrease in the strength of the strength module due to such a reduction. Another drawback arises with the decrease in available length of the internally-threaded apertures to receive the threaded fasteners resulting in a reduced length of thread engagement which could lead to thread failure under high loads. Another drawback is associated with the difficulty in forming the threads of the internally-threaded apertures using a stamping process during manufacturing.

Thus, there remains a need to develop alternative arrangements for strength modules for use in vehicular latches which reduce cost, complexity and weight, while improving packaging, such as by reducing the package size, and assembly, such as by improving the ease of assembly.

### SUMMARY

This section provides a general summary of the disclosure, and is not intended to be a comprehensive and exhaustive listing of all of its features or its full scope.

It is an object of the present disclosure to provide a latch assembly for motor vehicle closure applications having an improved strength module that addresses all of the known limitations of prior art strength modules.

In accordance with the above object, one aspect of the disclosure provides a latch assembly for a vehicle door that includes a frame plate having a plate segment with first and second retention apertures with a ratchet having a ratchet pivot aperture aligned with the first retention aperture and a pawl having a pawl pivot aperture aligned with the second retention aperture. Further, a first clinch nut is provided having a first post segment extending through the ratchet pivot aperture to support the ratchet for pivotal movement relative to the frame plate, with the first post segment having a first threaded portion and a second clinch nut is provided having a second post segment extending through the pawl pivot aperture to support the pawl for pivotal movement relative to the frame plate, with the second post segment having a second threaded portion. Further yet, first and second threaded fasteners are provided and configured for threaded engagement with corresponding ones of the first and second threaded portions of the first and second clinch nuts for securing latch assembly to the door.

In accordance with another aspect of the disclosure, the first and second post segments have tubular portions with internally threaded apertures, with the first and second threaded fasteners being configured for threaded receipt within the internally threaded apertures.

In accordance with another aspect of the disclosure, the first and second clinch nuts have interface segments extending axially from the first and second post segments, with the interface segments having a reduced diameter relative to the first and second post segments, wherein the interface segments are fixedly received in the first and second retention apertures, such as in an interference fit.

In accordance with another aspect of the disclosure, a shoulder extends between each of the first and second post segments and respective ones of the interface segments, wherein the shoulders are configured to facilitate assembly by confronting the plate segment of the frame plate upon securing the latch assembly to the door.

In accordance with another aspect of the disclosure, the first and second clinch nuts can be provided with flanges extending radially outwardly from the post segments, said flanges being configured to overlie and capture respective surfaces of the ratchet and the pawl.

In accordance with another aspect of the disclosure, at least one of the first and second clinch nuts can further include a projection extending axially from its flange away from the its post segment, with the projection supporting at least one of a ratchet biasing spring and a pawl biasing spring.

In accordance with another aspect of the disclosure, the latch assembly does not include any plate-like structure, such as a well-known back plate or the like, other than the frame plate.

In further accordance with the object, the present disclosure is directed to a latch assembly secured to an end face of a vehicle door. The latch assembly includes a frame plate having a plate segment with first and second retention apertures with a ratchet having a ratchet pivot aperture aligned with the first retention aperture and a pawl having a pawl pivot aperture aligned with the second retention aperture. A first clinch nut has a first post segment extending through the ratchet pivot aperture to support the ratchet for pivotal movement relative to the frame plate, with the first post segment having a first threaded portion. A second clinch nut has a second post segment extending through the pawl pivot aperture to support the pawl for pivotal movement relative to the frame plate, with the second post segment having a second threaded portion. Further, first and second threaded fasteners are configured in threaded engagement with corresponding ones of the first and second threaded portions of the first and second clinch nuts, wherein the vehicle door end face is sandwiched between enlarged heads of the first and second threaded fasteners and the first and second clinch nuts.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial perspective view of a motor vehicle having a side door equipped with a latch assembly embodying the teachings of the present disclosure;

FIG. 2 is a schematic illustration of a system block diagram of the latch assembly and exemplary control inputs;

FIG. 3 is a top perspective view of a strength module associated with the latch assembly of the present disclosure and illustrating a plurality of dual-function clinch nuts that are used for pivotably supporting the ratchet and pawl of the latch mechanism and for mounting the strength module to the vehicle side door;

FIG. 4 is a bottom perspective view of the strength module shown in FIG. 3 with the vehicle side door partially broken away;

FIG. 4A is a cross-sectional view taken through a fastener of the strength module of FIG. 4 taken generally along the line 4A-4A;

FIG. 5 is another top perspective view of a strength module similar to FIG. 3 that provides a three-point mounting arrangement;

FIG. 6 illustrates an exploded perspective view of some components of the latch mechanism of FIG. 5 including one of a plurality of clinch nuts in greater detail;

FIGS. 7 through 10 are various perspective views of an alternative embodiment of a strength module having clinch nuts in accordance with a further aspect of the present disclosure; and

FIG. 11 illustrates yet another alternative embodiment of a strength module for a latch assembly constructed in accordance with another aspect of the present disclosure.

Corresponding reference numerals are used throughout all of the drawings to indicate corresponding parts.

### DETAILED DESCRIPTION

One or more example embodiments of a strength module for a latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

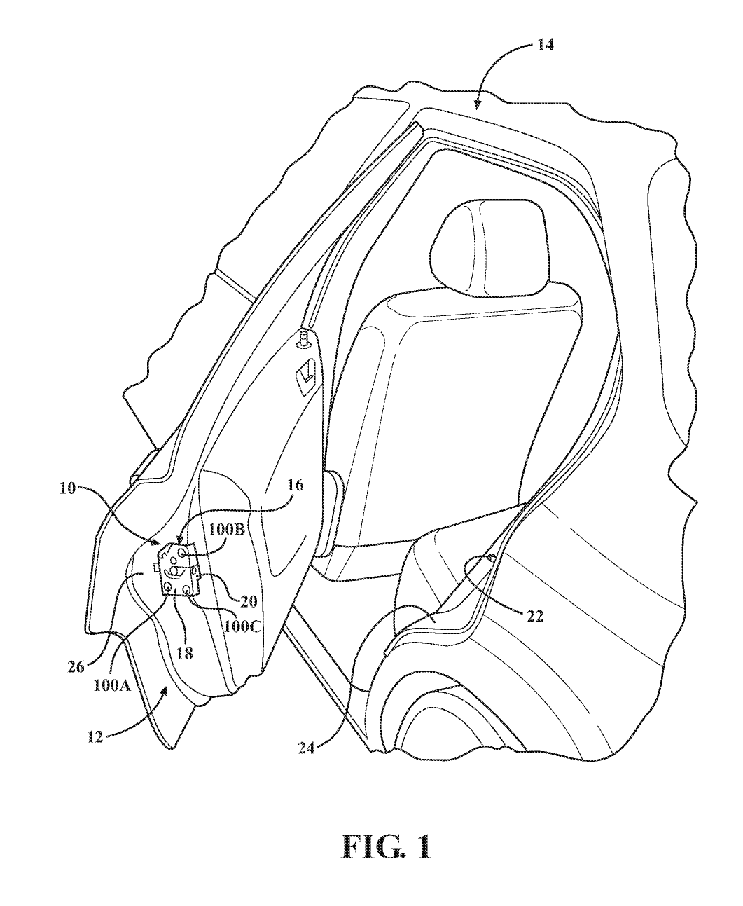

Referring initially to FIG. 1, a non-limiting example of a latch assembly 10 installed in a closure panel, such as, by way of example and without limitation, a side passenger door 12 of a motor vehicle 14, is shown. Latch assembly 10 includes a strength module 16 having a structural frame plate 18 and a latch mechanism 20. As is conventional, latch mechanism 20 is configured to releasably latch and hold a striker 22 mounted to a sill portion of vehicle body 24 when door 12 is closed. As will be detailed, strength module 16 provides an improved device for supporting latch mechanism 20 from frame plate 18 and for securing latch assembly 10 to an end face, also referred to as edge portion 26, of door 12.

Latch assembly 10 can be manually-operated or power-operated based on the specific vehicular application. To this end, latch assembly 10 of the present disclosure is considered to be applicable to virtually all closure latch arrangements (i.e. deck lid, hood, tailgate, etc.) and can include various features including, without limitations, power-release, power lock, power cinch and the like.

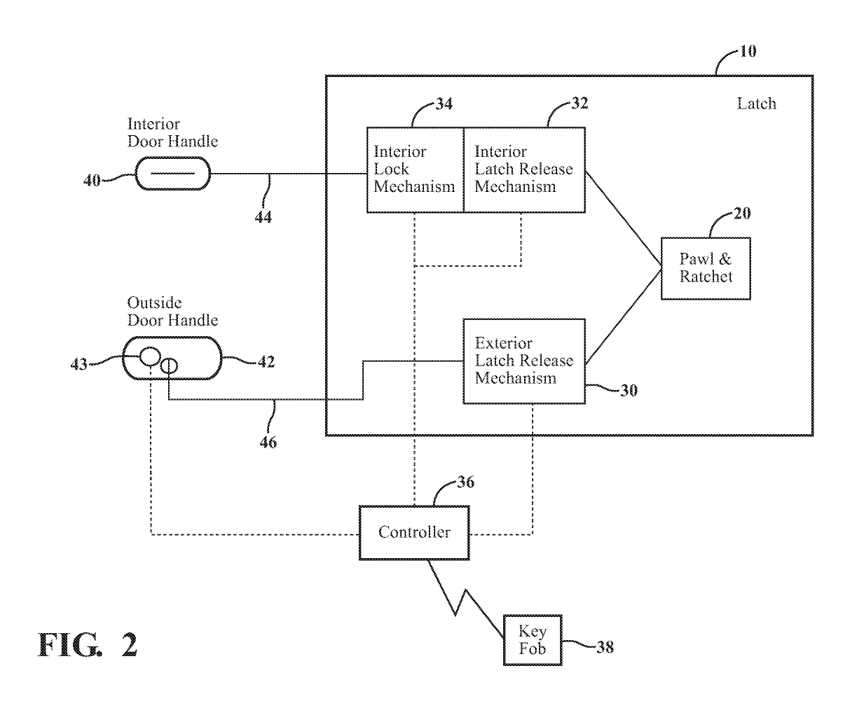

FIG. 2 illustrates latch assembly 10 in a non-limiting system-block form to include: latch mechanism 20; an electromechanical exterior latch release mechanism 30; an electromechanical interior latch release mechanism 32; an interior lock mechanism 34; a controller 36; a device for signaling controller 36, such as key fob 38; an interior door handle 40; and an outside door handle 42. Controller 36 functions to control actuation and resetting of the various power-operated mechanisms based on input signals provided by key fob 38 and/or input signals received from interior door handle 40 and outside door handle 42 from micro switches 43. As is known, mechanical latch release mechanisms can also be provided between interior door handle 40 and outside door handle 42, as indicated by hard lines 44 and 46, respectively. This block diagram is provided mainly to give support to the structure and function of the type of various mechanisms capable of being associated with latch assembly 10.

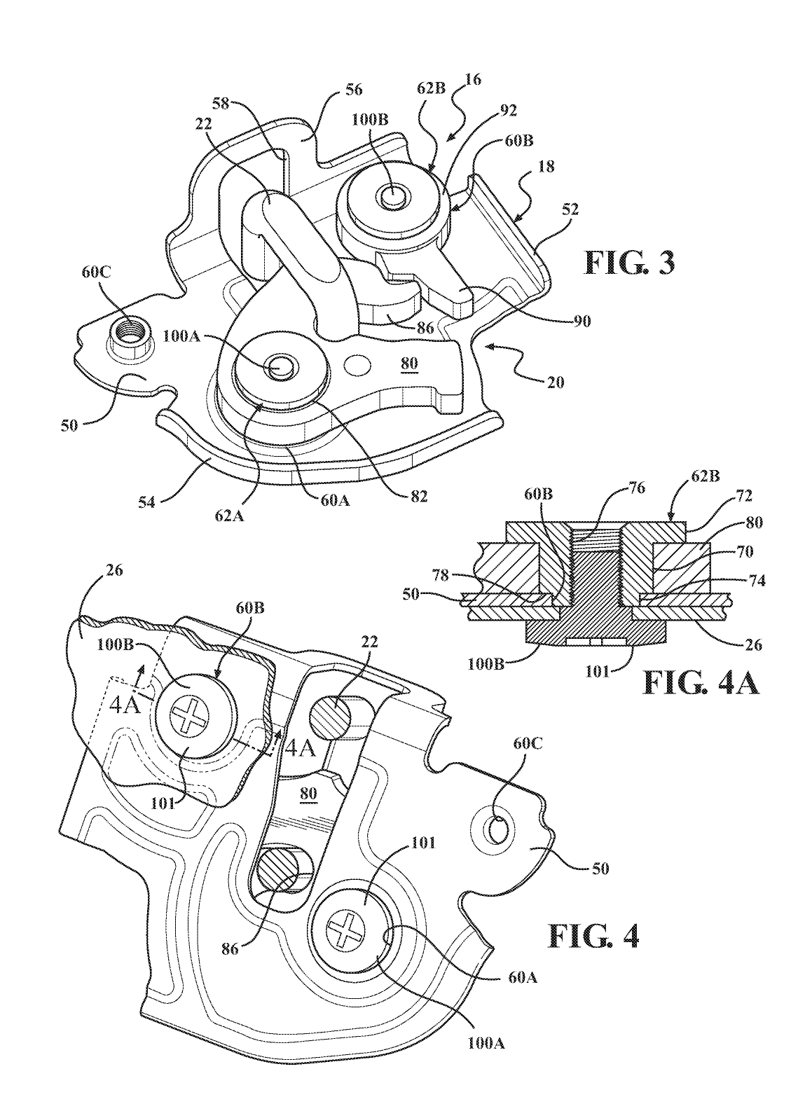

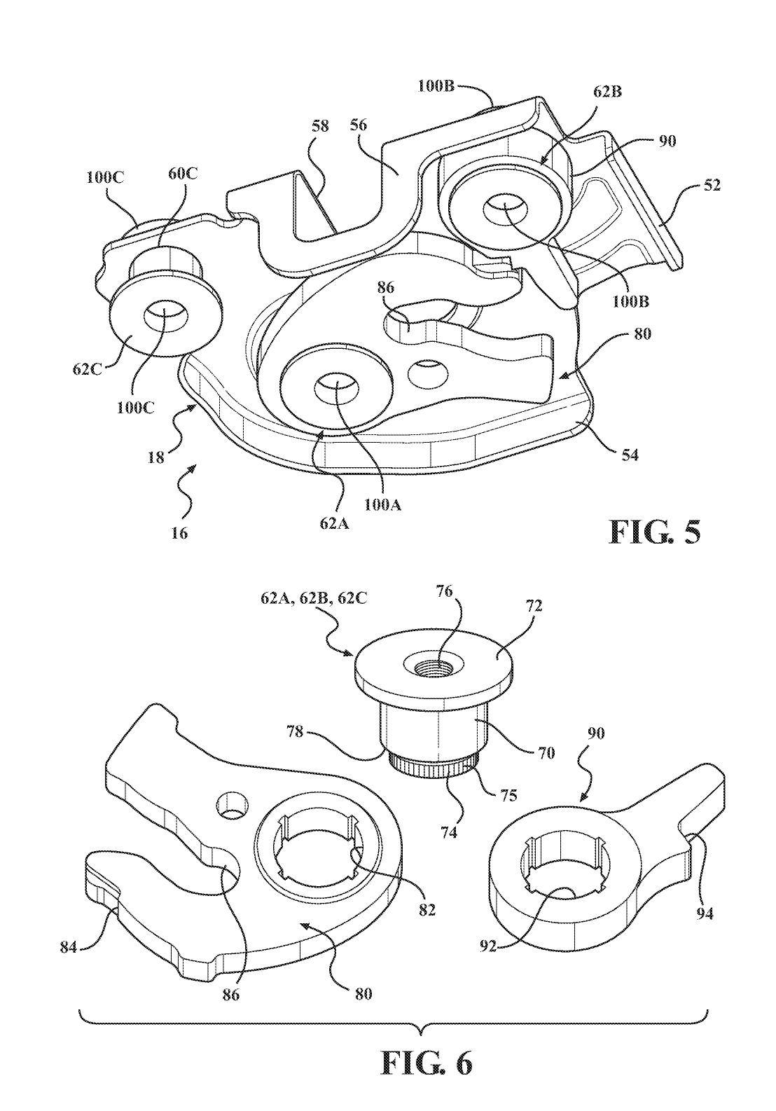

Referring now to FIGS. 3 through 6, a more detailed and exemplary embodiment of strength module 16 will be described. As noted, strength module 16 includes frame plate 18 and latch mechanism 20. Frame plate 18 includes a plate segment 50, a pair of edge flange segments 52 and 54, and a raised striker guide flange segment 56, each upstanding from a generally planar portion of plate segment 50. A continuous striker guide channel 58 is formed in striker guide flange segment 56 and plate segment 50 to allow striker 22 to move into and out of engagement with latch mechanism 20. Plate segment 50 is formed to include three (3) retention apertures 60A, 60B, 60C each configured to receive and retain a corresponding clinch nut 62A, 62B, 62C. FIGS. 3 and 4 show third retention aperture 60C, but not its corresponding clinch nut 62C; however, the preferred inclusion of the corresponding third clinch nut 62C and three retention hole arrangement is shown in FIG. 5. As best seen from FIG. 6, each clinch nut 62A, 62B, 62C includes a post segment, shown in a non-limiting embodiment as a tubular post segment 70, a flange, also referred to as disc segment 72, extending radially outwardly from a first end of post segment 70, thus having an enlarged diameter relative to the post segment 70, and a clinch interface segment 74 extending axially from a second end of post segment 70. While not limited thereto, the clinch interface segment 74 may have a reduced diameter dimension compared to the post segment 70 and second end of post segment 70 so as to define a shoulder, shown as a planar or substantially planar, annular shoulder surface 78 extending transversely to a longitudinal axis of the post segment 70 and between post segment 70 and clinch interface segment 74. A threaded portion, shown by way of example and without limitation as an internally threaded aperture 76, extends at least partially, and shown as completely through tubular clinch nut 62A, 62B, 62C.

First clinch nut 62A is shown with its tubular post segment 70 arranged to pivotably support a ratchet 80 associated with latch mechanism 20. Specifically, the tubular post segment 70 of first clinch nut 62A extends through a ratchet pivot aperture 82 formed in ratchet 80 and the annular disc segment 72 of first clinch nut 62A extends over a planar face surface of ratchet 80 in abutment therewith. Similarly, second clinch nut 62B is shown with its tubular post segment 70 arranged to pivotably support a pawl 90 associated with latch mechanism 20. Specifically, the tubular post segment 70 of second clinch nut 62B extends through a pawl pivot aperture 92 formed in pawl 90 with its disc segment 72 overlying a planar face surface of pawl 90 in abutment therewith.

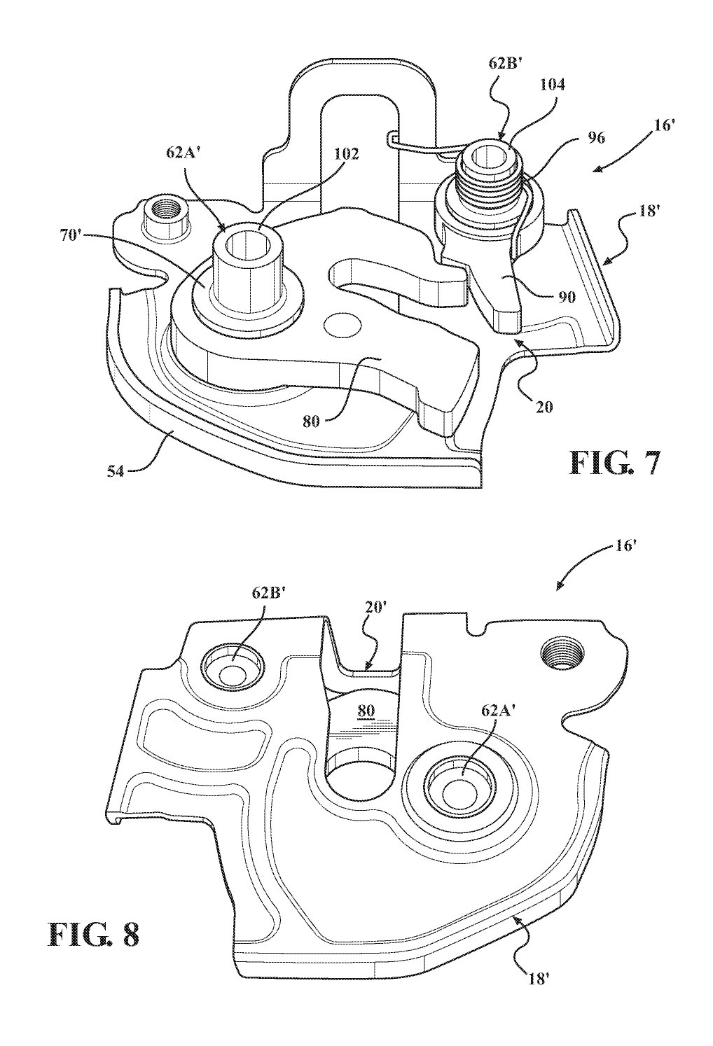

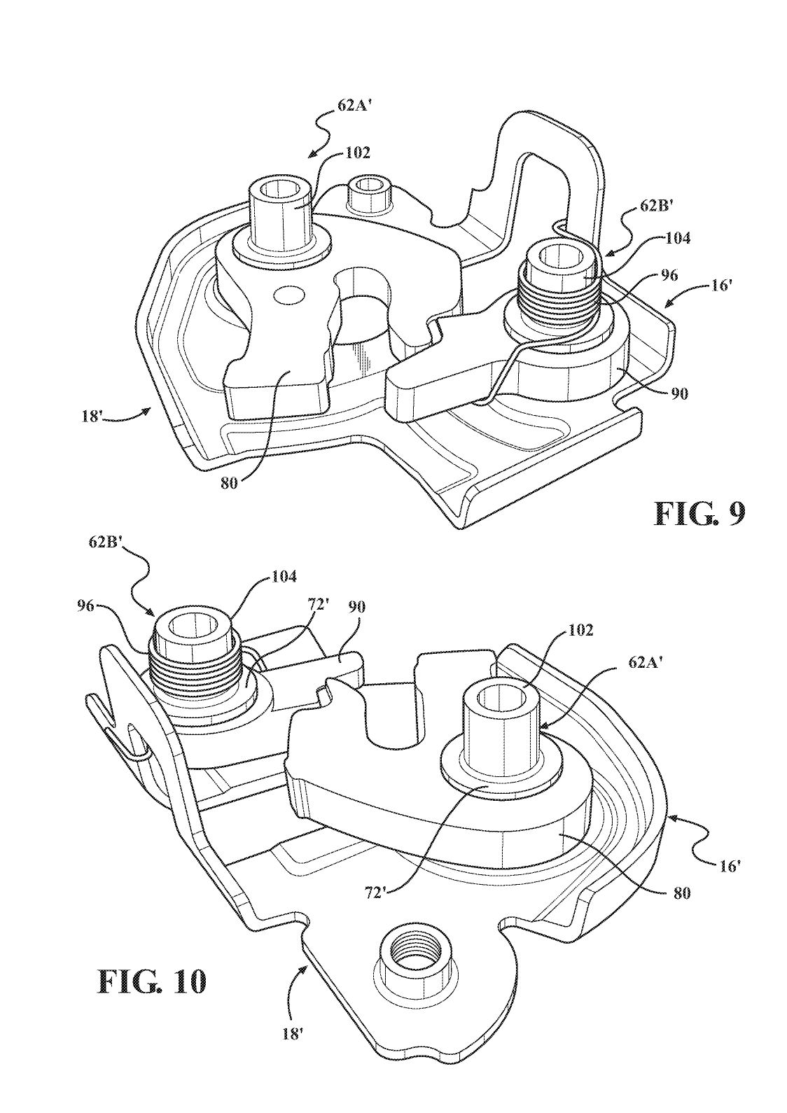

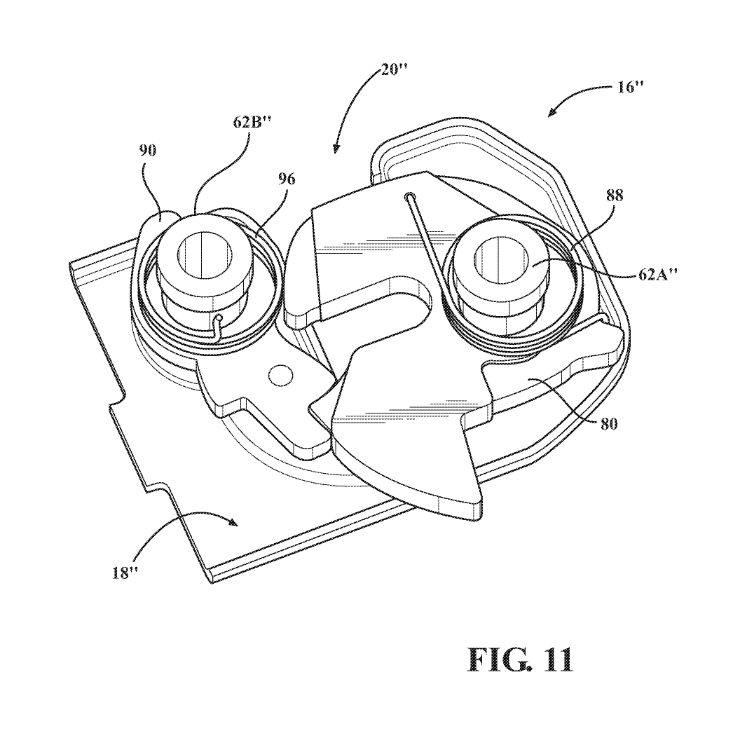

As is conventional, ratchet 80 is pivotable between a striker release position (not shown) and a striker capture position (FIGS. 3-5) and is normally biased toward its striker release position. A ratchet biasing spring 88 is shown in FIG. 11 for providing this normal biasing function. Pawl 90 is pivotable between a ratchet checking position (FIGS. 3, 5, 7-11) and a ratchet release position (not shown) and is normally biased toward its ratchet checking position. A pawl biasing spring 96 is shown in FIGS. 7 and 9-10 for providing this normal biasing function. With pawl 90 located in its ratchet checking position, ratchet 80 is mechanically held in its striker capture position via engagement of a pawl locking tab 94 with a ratchet locking notch 84 for holding striker 22 within striker guide channel 58 via its retention within a striker capture channel 86 formed in ratchet 80.

Upon alignment of ratchet pivot aperture 82 in ratchet 80 with first retention aperture 60A in plate segment 50 of frame plate 18, first clinch nut 62A is inserted until its clinch interface segment 74 is seated and firmly retained within first retention aperture 60A. Planar, annular shoulder surface 78 on first clinch nut 62A is resting on a planar surface of plate segment 50 of frame plate 18. Clinch interface segment 74 of first clinch nut 62A may include retention features 75 (FIG. 6), such as serrations, splines, lug or the like that are capable of providing an interference press-fit engagement within first retention aperture 60A so as to fixedly secure first clinch nut 62A to plate segment 50. Similarly, pawl aperture 92 in pawl 90 is aligned with second retention aperture 60B in plate segment 50 and then second clinch nut 62B is inserted until its clinch interface segment 74 is seated and firmly secured within second retention aperture 60B. Third clinch nut 62C is similarly mounted within third retention aperture 60C. Once the clinch nuts 62A, 62B, 62C are fixed to plate segment 50, strength module 16 is completely assembled, without need of known back plate(s), thereby readying latch assembly 10 to be mounted to door 12. It should be understood that the clinch nuts 62A, 62B, 62C can be configured identically or differently from one another depending on the intended application.

Threaded fasteners 100A, 100B, 100C are shown configured for threaded engagement with the threaded portion of post segment 70, and in a non-limiting embodiment, as best shown in FIG. 4A, the threaded fasteners 100A, 100B, 100C are shown having an externally threaded shank portion installed in the corresponding internally threaded aperture 76 formed in clinch nuts 62A, 62B, 62C, wherein the vehicle door end face 26 is sandwiched in fixed relation between enlarged heads 101 of the threaded fasteners 100A, 100B, 100C and the clinch nuts 62A, 62B, 62C for fixing latch assembly 10 to door 12. It is to be recognized that the fastener heads 101 can be provided with any suitable shape and tool receiving feature, with the non-limiting embodiment being shown as having a standard cross-head, sometime referred to as Phillips-head, tool receiving feature. As shown in FIG. 5, a generally triangular three-point mounting arrangement can be provided to securely mount latch assembly 10 to door 12. This arrangement does not rely on plate-like structures, such as well-known back plate(s), to be part of the structural mounting arrangement since the clinch nuts 62A, 62B, 62C provide stand-alone, self-supporting mounting structures for the latch components to the structural frame plate 18 and for attachment of the latch assembly 10 to the vehicle body 14 via threaded fasteners 100A, 100B, 100C. Thus, the clinch nuts 62A, 62B, 62C provide a dual function—first, to pivotably support the latch mechanism components and—second, to mount latch assembly 10 to the door 12. This dual function provides packaging improvements, including size and weight reduction and further increases the ease of assembly, as will be readily understood by one possessing ordinary skill in the art.

FIGS. 7-10 illustrate a strength module 16′, equipped with a frame plate 18′, a latch mechanism 20′, and clinch nuts 62A′, 62B′, constructed in accordance with another aspect of the disclosure. Again, a third clinch nut, corresponding to previously disclosed clinch nut 62, while not shown, is contemplated to provide the three-point mounting arrangement. Clinch nuts 62A′, 62B′ are similar to clinch nuts 62A, 62B except that an upstanding projection, shown by way of example and without limitation as a tubular extension 102, 104, extends axially along a lengthwise central axis from disc segments 72′ away from the post segments (concealed from view by the ratchet 80 and pawl 90) to provide a support structure for mounting additional features, including biasing springs, such as pawl spring 96 and ratchet bias spring (not shown), and to permit use of relatively increased length threaded fasteners than those shown in FIGS. 3-5, as will be understood by one possessing ordinary skill in the art. Accordingly, the disc segments 72′ are between and separate the post segments 70 from the tubular extensions 102, 104.

FIG. 11 illustrates a strength module 16″ constructed in accordance with yet another aspect of the disclosure having a frame plate 18″, a latch mechanism 20″, and a pair of clinch nuts 62A″, 62B″ providing a two-point mounting arrangement.

In accordance with the above disclosure, latch assembly 10 can be fixed to door 12 by threaded clinch nuts 62 configured to withstand the requires strip torque; the thickness of frame plate 18 can be reduced and the configuration of frame plate 18 can be optimized as a result of the minimal loads applied thereto given latch assembly 10 is directly connected to door 12 by threaded fasteners 100A, 100B, 100C threadingly fixed within clinch nuts 62A, 62B, 62C in a coaxial relation to ratchet 80 and pawl 90; the size and weight of latch assembly 10 can be minimized while at the same time having a relatively high strength; the need for blind fasteners, such as rivets and two-side riveting operations are eliminated; and the elimination of a back plate is provided, thereby contributing to reduced weight and cost.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a vehicle door, comprising:
a frame plate having a plate segment with first and second retention apertures;
a ratchet having a ratchet pivot aperture aligned with said first retention aperture;
a pawl having a pawl pivot aperture aligned with said second retention aperture;
a first clinch nut having a first post segment extending through said ratchet pivot aperture to support said ratchet for pivotal movement relative to said frame plate, said first post segment having a first threaded portion;
a second clinch nut having a second post segment extending through said pawl pivot aperture to support said pawl for pivotal movement relative to said frame plate, said second post segment having a second threaded portion; and
first and second threaded fasteners configured for threaded engagement with corresponding ones of said first and second threaded portions of said first and second clinch nuts for securing said latch assembly to the vehicle door.

2. The latch assembly of claim 1, wherein said first and second post segments have tubular portions with internally threaded apertures, said first and second threaded fasteners being configured for threaded receipt within said internally threaded apertures.

3. The latch assembly of claim 2, wherein said first and second clinch nuts have interface segments extending axially from said first and second post segments, said interface segments having a reduced diameter relative to said first and second post segments, wherein said interface segments are fixedly received in said first and second retention apertures.

4. The latch assembly of claim 3, wherein a shoulder extends between each of said first and second post segments and respective ones of said interface segments, said shoulder confronting said plate segment of said frame plate upon securing the latch assembly to the vehicle door.

5. The latch assembly of claim 3, wherein said interface segments are press-fit in an interference fit into said first and second retention apertures.

6. The latch assembly of claim 2, wherein said first and second clinch nuts have flanges extending radially outwardly from said post segments, said flanges being configured to overlie respective surfaces of said ratchet and said pawl.

7. The latch assembly of claim 6, wherein at least one of said first and second clinch nuts further includes an extension extending axially from said flanges away from said first and second post segments, said extension supporting at least one of a ratchet biasing spring and a pawl biasing spring.

8. The latch assembly of claim 7, wherein each of said first and second clinch nuts further includes said extension extending axially from said flanges away from said first and second post segments, wherein separate ones of said extensions support said ratchet biasing spring and said pawl biasing spring.

9. The latch assembly of claim 1, wherein said frame plate has a third retention aperture, and further including a third clinch nut having a third post segment with a third threaded portion, and further including a third threaded fastener configured for threaded engagement with said third threaded portion of said third clinch nut for further securing said latch assembly to the vehicle door.

10. The latch assembly of claim 1, wherein latch assembly does not include any plate-like structure other than said frame plate.

11. A latch assembly secured to an end face of a vehicle door, said latch assembly, comprising:
a frame plate having a plate segment with first and second retention apertures;
a ratchet having a ratchet pivot aperture aligned with said first retention aperture;
a pawl having a pawl pivot aperture aligned with said second retention aperture;
a first clinch nut having a first post segment extending through said ratchet pivot aperture to support said ratchet for pivotal movement relative to said frame plate, said first post segment having a first threaded portion;
a second clinch nut having a second post segment extending through said pawl pivot aperture to support said pawl for pivotal movement relative to said frame plate, said second post segment having a second threaded portion; and
first and second threaded fasteners configured in threaded engagement with corresponding ones of said first and second threaded portions of said first and second clinch nuts, wherein said vehicle door end face is sandwiched in fixed relation between enlarged heads of said first and second threaded fasteners and said first and second clinch nuts.

12. The latch assembly of claim 11, wherein said first and second post segments have tubular portions with internally threaded apertures, said first and second threaded fasteners being configured for threaded receipt within said internally threaded apertures.

13. The latch assembly of claim 12, wherein said first and second clinch nuts have interface segments extending axially from said first and second post segments, said interface segments being fixedly received in said first and second retention apertures.

14. The latch assembly of claim 13, wherein a shoulder extends between each of said first and second post segments and respective ones of said interface segments, said shoulder confronting said plate segment of said frame plate.

15. The latch assembly of claim 13, wherein said interface segments are press-fit in an interference fit into said first and second retention apertures.

16. The latch assembly of claim 12, wherein said first and second clinch nuts have flanges extending radially outwardly from said post segments, said flanges overlying respective surfaces of said ratchet and said pawl.

17. The latch assembly of claim 16, wherein at least one of said first and second clinch nuts further includes an extension extending axially from said flanges away from said first and second post segments, said extension supporting at least one of a ratchet biasing spring and a pawl biasing spring.

18. The latch assembly of claim 17, wherein each of said first and second clinch nuts further includes said extension extending axially from said flanges away from said first and second post segments, wherein separate ones of said extensions support said ratchet biasing spring and said pawl biasing spring.

19. The latch assembly of claim 11, wherein said frame plate has a third retention aperture, and further including a third clinch nut having a third post segment with a third threaded portion, and further including a third threaded fastener configured for threaded engagement with said third threaded portion of said third clinch nut, said vehicle door end face being sandwiched in fixed relation between an enlarged head of said third threaded fastener and said third clinch nut.

20. The latch assembly of claim 11, wherein latch assembly does not include any plate-like structure other than said frame plate.
